(19) United States
(12) Patent Application Publication
(10) Pub. No.: US 2009/0252935 A1
(43) Pub. Date: Oct. 8, 2009

(54) MULTILAYER FILM FOR USE IN SIMULTANEOUS INJECTION MOLDING-LAMINATION METHOD

(75) Inventors: Koji KOYAMA, Niihama-shi (JP); Shinsuke OCHIAI, Niihama-shi (JP)

Correspondence Address: BIRCH STEWART KOLASCH & BIRCH, PO BOX 747, FALLS CHURCH, VA, 22040-0747, US

(73) Assignee: SUMITOMO CHEMICAL COMPANY, LIMITED, Tokyo (JP)

(21) Appl. No.: 12/413,295

(22) Filed: Mar. 27, 2009

(30) Foreign Application Priority Data
Mar. 28, 2008 (JP) 2008-086240

(51) Int. Cl. B32B 3/00; B32B 27/08

(52) U.S. Cl. 428/195.1; 428/412

(57) ABSTRACT

A multilayer film for use in a simultaneous injection molding-lamination method comprising a layer (A) formed of a polycarbonate resin and a layer (B) formed of a methacrylic resin and acrylic rubber particles, which is laminated on at least one surface of the layer (A). The multilayer film is preferably used as a decorative film having high heat resistance and high surface hardness.

### FIELD OF THE INVENTION

The present invention relates to a multilayer film for use in a simultaneous injection molding-lamination method. Furthermore, the present invention relates to a decorative film or sheet and also a decorative molded article, each comprising a multilayer film.

### BACKGROUND ART

Methacrylic resin films are preferably used as surface-decorative films for the exterior members of household electric appliances and the interior members of automobiles by making the best use of their excellent transparency and weathering resistance. The members which are surface-decorated with the methacrylic resin films are advantageously manufactured by a simultaneous injection molding-lamination method. Specifically, a decorated methacrylic resin film is inserted in an injection mold, and a resin melt is injected into the mold to form an injection-molded article and simultaneously the methacrylic resin film is laminated on the injection-molded article to obtain a decorative molded article as the above-described member.

The methacrylic resin film for use in the simultaneous injection molding-lamination method often contains acrylic rubber particles to impart mechanical strengths necessary for the film (see JP-A-8-323934, JP-A-10-279766, JP-A-11-147237 and JP-A-2002-80678). However, such a methacrylic resin film has a disadvantage such as low heat resistance. Thus, such a film is apt to deform or shrink at a high temperature of 100° C. or higher. On the other hand, a polycarbonate resin film is known as a resin film having high heat resistance, but it has some drawbacks such that the polycarbonate resin has low surface hardness and requires a high heating temperature for molding it, and thus a molding cycle becomes longer.

### SUMMARY OF THE INVENTION

An object of the present invention is to provide a film having high heat resistance and high surface hardness, suitable for use in a simultaneous injection molding-lamination method. Another object of the present invention is to provide a decorative film or sheet and also a decorative molded article, each of which comprises such a film and thus has high heat resistance and high surface hardness.

As the result of extensive studies by the present inventors, it has been found that the above objects can be achieved by providing a multilayer film which comprises a polycarbonate resin layer and a specific methacrylic resin layer as a film for use in a simultaneous injection molding-lamination method, and the present invention has been accomplished based on such a finding. Accordingly, the present invention provides a multilayer film for use in a simultaneous injection molding-lamination method comprising a layer (A) formed of a polycarbonate resin and a layer (B) formed of a methacrylic resin and acrylic rubber particles, which is laminated on at least one surface of the layer (A).

When a decorative pattern is formed on the layer (A) of the multilayer film which is prepared by laminating the layer (B) on one surface of the layer (A), such a film can be used as a decorative film having high heat resistance and high surface hardness. When a decorative pattern is formed on one surface of the multilayer film which is prepared by laminating the layers (B) on both surfaces of the layer (A), such a film can be used likewise as a decorative film having high heat resistance and high surface hardness. Further, a decorative sheet can be obtained by laminating a thermoplastic resin sheet on the decorative pattern-formed surface of any of these decorative films. Further, a decorative molded article having high heat resistance and high surface hardness can be obtained by injection-molding a thermoplastic resin onto the decorated surface of the decorative film or the thermoplastic resin sheet of the decorative sheet.

The multilayer film of the present invention for use in the simultaneous injection molding-lamination method has high heat resistance and high surface hardness. Therefore, this multilayer film of the present invention can be used to produce a decorative film or sheet, and a decorative molded article, each having high heat resistance and high surface hardness.

### DETAILED DESCRIPTION OF THE INVENTION

Hereinafter, the present invention will be described in detail. The multilayer film of the present invention for use in the simultaneous injection molding-lamination method is produced by laminating a layer (B) which comprises a methacrylic resin and acrylic rubber particles on at least one surface of a layer (A) which comprises a polycarbonate resin.

Examples of the polycarbonate resin forming the layer (A) include polycarbonate prepared by reacting a dihydric phenol with a carbonylating agent by an interfacial polycondensation method or a melt transesterification method; polycarbonate prepared by polymerizing a carbonate prepolymer by a solid phase transesterification method; and polycarbonate prepared by polymerizing a cyclic carbonate compound by a ring-opening polymerization method.

Specific examples of the dihydric phenol include hydroquinone, resorcinol, 4,4′-dihydroxydiphenyl, bis(4-hydroxyphenyl)methane, bis{(4-hydroxy-3,5-dimethyl)phenyl}-methane, 1,1-bis(4-hydroxyphenyl)ethane, 1,1-bis(4-hydroxyphenyl)-1-phenylthane, 2,2-bis(4-hydroxyphenyl)-propane (bisphenol A), 2,2-bis{(4-hydroxy-3-methyl)phenyl}-propane, 2,2-bis{(4-hydroxy-3,5-dimethyl)phenyl}propane, 2,2-bis{(4-hydroxy-3,5-dibromo)phenyl}propane, 2,2-bis{(3-isopropyl-4-hydroxy)phenyl}propane, 2,2-bis{(4-hydroxy-3-phenyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,4-bis(4-hydroxyphenyl)-2-methylbutane, 2,2-bis(4-hydroxyphenyl)-pentane, 2,2-bis(4-hydroxyphenyl)-4-methylpentane, 1,1-bis(4-hydroxyphenyl)cyclohexane, 1,1-bis(4-hydroxyphenyl)-4-isopropylcyclohexane, 1,1-bis(4-hydroxyphenyl)-3,3,5-trimethylcyclohexane, 9,9-bis(4-hydroxyphenyl)fluorene, 9,9-bis{(4-hydroxy-3-methyl)phenyl}fluorene, α,α′-bis(4-hydroxyphenyl)-o-diisopropylbenzene, α,α′-bis(4-hydroxyphenyl)-m-diisopropylbenzene, α,α′-bis(4-hydroxyphenyl)-p-diisopropylbenzene, 1,3-bis(4-hydroxyphenyl)-5,7-dimethyladamantane, 4,4′-dihydroxy-diphenylsulfone, 4,4′-dihydroxydiphenylsulfoxide, 4,4′-dihydroxydiphenylsulfide, 4,4′-dihydroxydiphenylketone, 4,4′-dihydroxydiphenylether, 4,4′-dihydroxydiphenylester, etc. They may be used independently or as a mixture of two or more of them.

Among them, bisphenol A, 2,2-bis{(4-hydroxy-3-methyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,2-bis(4-hydroxyphenyl)-4-methylpentane, 1,1-bis(4-hydroxyphenyl)-3,3,5-trimethylcyclohexane and α,α′-bis(4-hydroxyphenyl)-m-diisopropylbenzene or a mixture of two or more of them are preferably used. In particular, bisphenol A alone, or a mixture of 1,1-bis(4-hydroxyphenyl)-3,3,5-trimethyl-cyclohexane with at least one dihydric phenol selected from the group consisting of bisphenol A, 2,2-bis{(4-hydroxy-3-methyl)phenyl}propane and α,α′-bis(4-hydroxyphenyl)-m-diisopropylbenzene is preferably used.

Examples of the carbonating agent include carbonyl halides such as phosgene, carbonate esters such as diphenyl carbonate, haloformates such as dihaloformate of a dihydric phenol, etc. They may be used independently or as a mixture of two or more of them.

The methacrylic resin constituting the layer (B) is a polymer comprising a methacrylate. The methacrylic resin may be a homopolymer of a methacrylate or a copolymer of 50% by weight or more of a methacrylate and 50% by weight or less of a monomer other than the methacrylate. As the methacrylate, an alkyl methacrylate is generally used.

Preferably, the methacrylic resin comprises 50 to 100% by weight of an alkyl methacrylate, 0 to 50% by weight of an alkyl acrylate, and 0 to 49% by weight of a monomer other than the alkyl methacrylate and alkyl acrylate, based on the total weight of the monomers. More preferably, the methacrylic resin comprises 50 to 99.9% by weight of an alkyl methacrylate, 0.1 to 50% by weight of an alkyl acrylate, and 0 to 49% by weight of a monomer other than the alkyl methacrylate and alkyl acrylate, based on the total weight of the monomers.

The number of carbon atoms in the alkyl group of the alkyl methacrylate is preferably from 1 to 8, more preferably from 1 to 4. Specific examples of the alkyl methacrylate include methyl methacrylate, ethyl methacrylate, butyl methacrylate, 2-ethylhexyl methacrylate, etc. Among them, methyl methacrylate is preferably used.

The number of carbon atoms in the alkyl group of the alkyl acrylate is preferably from 1 to 8, more preferably from 1 to 4. Specific examples of the alkyl acrylate include methyl acrylate, ethyl acrylate, butyl acrylate, 2-ethylhexyl acrylate, etc.

The monomer other than the alkyl methacrylate and alkyl acrylate may be a monofunctional monomer, i.e., a compound having one polymerizable carbon-carbon double bond in a molecule, or a polyfunctional monomer, i.e. a compound having at least two polymerizable carbon-carbon double bonds in a molecule. Among them, the monofunctional monomer is preferably used. Examples of the monofunctional monomer include aromatic alkenyl compounds such as styrene, a-methylstyrene and vinyl toluene, alkenylcyanide compounds such as acrylonitrile and methacylonitrile, acrylic acid, methacrylic acid, maleic anhydride, N-substituted maleimide, etc. Examples of the polyfunctional monomer include polyunsaturated carboxylates of polyhydric alcohols such as ethylene glycol dimethacrylate, butanediol dimethacrylate and trimethylolpropane triacrylate, alkenyl esters of unsaturated carboxylic acids such as allyl acrylate, allyl methacrylate and allyl cinnamate, polyalkenyl esters of polybasic acids such as diallyl phthalate, diallyl maleate, triallyl cyanurate and triallyl isocyanurate, aromatic polyalkenyl compounds such as divinylbenzene, etc.

Optionally, two or more of the alkyl methacrylates, two or more of the alkyl acrylates and/or two or more of the monomers other than the alkyl methacrylate and alkyl acrylate may be used.

The methacrylic resin preferably has a glass transition temperature of 40° C. or higher, more preferably 60° C. or higher, from the viewpoint of the heat resistance of the layer (B). The glass transition temperature of the methacrylic resin may be appropriately adjusted by selecting the kinds of the monomers and the proportion thereof.

The methacrylic resin is prepared by polymerizing a monomer or monomers by a suitable polymerization method such as suspension polymerization, emulsion polymerization or bulk polymerization. In the polymerization, a chain transfer agent is preferably used in order for the methacrylic resin to have a suitable glass transition temperature or to have a viscosity suitable for moldability to form a multilayer film. The amount of the chain transfer agent may be appropriately selected according to the kinds of the monomers and the proportion thereof.

Since the layer (B) is formed of a composition containing the methacrylic resin and the acrylic rubber particles, the multilayer film comprising such a layer (B) can have improved flexibility.

The acrylic rubber particles contain an elastic polymer comprising an acrylate as a rubber component. The acrylic rubber particles may be particles with a single-layer structure consisting of the elastic polymer, or may be particles with a multilayer structure comprising at least one layer of the elastic polymer. The acrylic rubber particles preferably have a multilayer structure from the viewpoint of the surface hardness of the layer (B). The elastic polymer may be a homopolymer of an acrylate or a copolymer comprising 50% by weight or more of an acrylate and 50% by weight or less of other monomer. As the acrylate, an alkyl acrylate is preferably used.

Preferably, the elastic polymer comprising an acrylate comprises 50 to 99.9% by weight of an alkyl acrylate, 0 to 49.9% by weight of an alkyl methacrylate, 0 to 49.9% by weight of a monofunctional monomer other than the alkyl acrylate and alkyl methacrylate, and 0.1 to 10% by weight of a polyfunctional monomer, based on the total weight of the monomers.

Examples of the alkyl acrylate are the same as the alkyl acrylate exemplified as the monomer component of the methacrylic resin. The number of carbon atoms in the alkyl group is prefrably from 1 to 8, more preferably 4 to 8. Examples of the alkyl methacrylate are also the same as the alkyl methacrylate exemplified as the monomer component of the methacrylic resin. The number of carbon atoms in the alkyl group is preferably from 1 to 8, more preferably 1 to 4.

Examples of the monofunctional monomer other than these monomers are the same as the monofunctional monomer other than alkyl methacrylate and alkyl acrylate exemplified as the monomer component of the methacrylic resin. Among them, an aromatic alkenyl compound such as styrene, α-methylstyrene or vinyl toluene is preferably used.

Examples of the polyfunctional monomer are the same as the polyfunctional monomer exemplified as the monomer component of the methacrylic resin. Among them, an alkenyl ester of an unsaturated carboxylic acid or a polyalkenyl ester of a polybasic acid is preferably used.

Optionally, two or more of the alkyl acrylates, two or more of the monofunctional monomers other than the alkyl acrylates, and/or two or more of the polyfunctional monomers may be used.

When the particles with a multilayer structure are used as the acrylic rubber particles, preference is given to particles with a multilayer structure having a layer of an elastic polymer comprising an acrylate and a layer of a polymer comprising a methacrylate which is formed around outside the layer of an elastic polymer, that is, particles having at least two layers, i.e., an inner layer of the elastic polymer comprising the acrylate and an outer layer of the polymer comprising the methacrylate. As the methacrylate used as the monomer component of the polymer for the outer layer, an alkyl methacrylate is preferably used. The polymer for the outer layer is preferably used in an amount of 10 to 400 parts by weight, more preferably 20 to 200 parts by weight, per 100 parts by weight of the elastic polymer for the inner layer. When 10 parts by weight or more of the polymer for the outer layer is used per 100 parts by weight of the elastic polymer for the inner layer, the elastic polymer particles hardly agglomerate, so that the transparency of the layer (B) is improved.

Preferably, the polymer for the outer layer comprises 50 to 100% by weight of an alkyl methacrylate, 0 to 50% by weight of an alkyl acrylate, 0 to 50% by weight of a monomer other than the alkyl methacrylate and alkyl acrylate, and 0 to 10% by weight of a polyfunctional monomer, based on the total weight of the monomers.

Examples of the alkyl methacrylate are the same as the alkyl methacrylate exemplified as the monomer component of the methacrylic resin. The number of carbon atoms in the alkyl group is preferably from 1 to 8, more preferably from 1 to 4. Among them, methyl methacrylate is preferably used.

Examples of the alkyl acrylate are the same as the alkyl acrylate exemplified as the monomer component of the methacrylic resin. The number of carbon atoms in the alkyl group is preferably from 1 to 8, more preferably from 1 to 4.

Examples of the monomer other than the alkyl methacrylate and alkyl acrylate are the same as the monofunctional monomer other than the alkyl methacrylate and alkyl acrylate exemplified as the monomer component of the methacrylic resin. Examples of the polyfunctional monomer are the same as the polyfunctional monomer exemplified as the monomer component of the methacrylic resin.

Optionally, two or more of the alkyl methacrylates, two or more of the alkyl acrylates, two or more of the monofunctional monomers other than the alkyl methacrylates and alkyl acrylates, and/or two or more of the polyfunctional monomers may be used.

A further example of the rubber particles with a multilayer structure are rubber particles with a multilayer structure having at least three layers, that is, an inner layer of a polymer comprising a methacrylate, an intermediate layer of an elastic polymer comprising an acrylate and an outer layer of a polymer comprising a methacrylate. In other words, the particles having such a multilayer structure are the modification of the particles with a two-layer structure by forming a further layer of a polymer comprising a methacrylate inside the inner layer of the two-layer structure. As the methacrylate as the monomer component of the polymer for the inner layer, an alkyl methacrylate is preferably used. The polymer for the inner layer is preferably used in an amount of from 10 to 400 parts by weight, more preferably from 20 to 200 parts by weight, per 100 parts by weight of the elastic polymer for the intermediate layer.

The polymer for the inner layer preferably comprises 70 to 100% by weight of an alkyl methacrylate, 0 to 30% by weight of an alkyl acrylate, 0 to 30% by weight of a monomer other than the alkyl methacrylate and alkyl acrylate, and 0 to 10% by weight of a polyfunctional monomer, based on the total weight of the monomers.

Examples of the alkyl methacrylate are the same as the alkyl methacrylate exemplified as the monomer component of the methacrylic resin. The number of carbon atoms in the alkyl group is preferably from 1 to 8, more preferably from 1 to 4. Among them, methyl methacrylate is preferably used. Examples of the alkyl acrylate are the same as the alkyl acrylate exemplified as the monomer component of the methacrylic resin The number of carbon atoms in the alkyl group is preferably from 1 to 8, more preferably from 1 to 4.

Examples of the monomer other than alkyl methacrylate and alkyl acrylate are the same as the monofunctional monomer other than the alkyl methacrylate and alkyl acrylate exemplified as the monomer component of the methacrylic resin. Examples of the polyfunctional monomer are the same as the polyfunctional monomer exemplified as the monomer component of the methacrylic resin.

Optionally, two or more of the alkyl methacrylates, and/or two or more of the monomers other than the alkyl methacrylates may be used.

The acrylic rubber particles may be prepared as follows: the monomer components of the elastic polymer comprising the acrylate are polymerized in at least one step of reaction by emulsion polymerization or the like. When the layer of the polymer comprising the methacrylate is formed on the outer surface of the layer of the elastic polymer as described above, the monomer components of the polymer for this outer layer are polymerized in at lest one step of reaction in the presence of the elastic polymer by emulsion polymerization or the like, to graft the resultant polymer on the elastic polymer. When the layer of the polymer comprising the methacrylate is additionally present inside the layer of the elastic polymer as described above, firstly, the monomer components of the polymer for this inner layer are polymerized in at least one step of reaction by emulsion polymerization or the like; then, the monomer components of the elastic polymer are polymerized in at least one step of reaction in the presence of the resultant polymer by emulsion polymerization or the like, to graft the resultant elastic polymer on the polymer for the inner layer; and then the monomer components of the polymer for the outer layer are polymerized in at least one step of reaction in the presence of the resultant elastic polymer by emulsion polymerization or the like, to graft the resultant polymer on the elastic polymer. When the polymerization for each layer is carried out in two or more steps of reactions, the monomer composition of each layer as a whole, but not the monomer composition in each reaction step, should fall within the above-specified range.

For the acrylic rubber particles, the average particle size of the layer of the elastic polymer comprising the acrylate is preferably from 0.01 to 0.4 μm, more preferably from 0.05 to 0.3 μm, still more preferably from 0.07 to 0.25 μm. When this average particle size is too large, the transparency of the layer (B) undesirably tends to decrease. When this average particle size is too small, the surface hardness of the layer (B) undesirably tends to deteriorate, and the layer (B) is easily flawed and has degraded flexibility so that it is easily cracked.

This average particle size is determined as follows: the acrylic rubber particles are mixed with the methacrylic resin to form a film; the layer of the elastic polymer in the section of the film is dyed with ruthenium oxide; and the section of the film is observed with an electron microscope to find the diameter of the dyed portion. This method is described in more detail: when the section of the film formed of the mixture of the acrylic rubber particles and the methacrylic resin is dyed with ruthenium oxide, the methacrylic resin as a matrix is not dyed. In addition, when a layer of a polymer comprising a methacrylate is present outside the layer of the elastic polymer, the polymer of this outer layer is not dyed either. As a result, only the layer of the elastic polymer is dyed, which makes it possible to determine the particle size from the diameter of the substantially circular dyed portion observed with the electron microscope. When a layer of a polymer comprising a methacrylate is present inside the layer of the above-described elastic polymer, this inner layer is not dyed either, so that each particle is observed as if it has a two-layer structure in which the layer of the elastic polymer outside the inner layer is dyed. In this case, the particle diameter may be determined from the outer diameter of the outer layer of the two-layer structure, i.e., the layer of the elastic polymer.

In the composition of the methacrylic resin and the acrylic rubber particles, the amount of the methacrylic resin is preferably from 40 to 90 parts by weight, while the amount of the acrylic rubber particles is preferably from 10 to 60 parts by weight, per 100 parts by weight of the total amount of the methacrylic resin and the acrylic rubber particles. When the amount of the methacrylic resin is too small and thus the amount of the acrylic rubber particles is too large, the surface hardness of the resultant layer (B) tends to decrease. As a result, the layer (B) is easily flawed, which results in a poor external appearance of the resultant product having a decorative pattern transferred thereto.

The amount of the elastic polymer comprising the acrylate in the acrylic rubber particles is preferably from 10 to 50 parts by weight, more preferably from 15 to 50 parts by weight, per 100 parts by weight of the total amount of the methacrylic resin and the acrylic rubber particles.

The methacrylic resin constituting the layer (B) may optionally contain other components or additives, for example, a UV absorber, an organic dye, an inorganic dye, a pigment, an antioxidant, an antistatic agent, a surfactant, etc. besides the acrylic rubber particles.

To impart a matte design to the film, it is effective to add organic or inorganic fine particles to the polycarbonate resin constituting the layer (A) and/or the composition of the methacrylic resin and the acrylic rubber particles, constituting the layer (B) to form the layer (A) and/or the layer (B) as light-diffusing matte layer(s). As the organic fine particles, for example, crosslinked acrylic polymer particles or crosslinked styrenic polymer particles may be used. As the inorganic fine particles, for example, silica or alumina particles may be used. The amount of the fine particles is appropriately selected in accordance with a desired surface gloss or designed pattern. The amount of the fine particles is usually from about 0.1 to about 50% by weight based on the total weight of all the materials constituting the layer(s) containing the fine particles.

The multilayer film is constituted by the layer (A) formed of the polycarbonate resin and the layer (B) formed of the composition of the methacrylic resin and the acrylic rubber particles as described above, so that the layer (B) of the composition of the methacrylic resin and the acrylic rubber particles is formed on at least one surface of the layer (A) of the polycarbonate resin. Thus, the multilayer film of the present invention for use in the simultaneous injection molding-lamination method is obtained. A method for manufacturing the multilayer film may be appropriately selected. For example, the following methods are advantageously employed: a co-extrusion method in which the components of the respective layers are molten with extruders, respectively, and the resulting melts are then co-extruded and laminated on each other by a feed block method or a multimanifold method; or a polycarbonate resin is formed into a film by extrusion, and the resulting film is coated on its surface with the composition of the methacrylic resin and the acrylic rubber particles which may optionally be dissolved in a solvent. Of these methods, the co-extrusion method is preferably employed.

In the co-extrusion method, the co-extruded resin melts are contacted to rolls or belts to form a film. The number of the rolls or the belts, the arrangement thereof and the materials thereof are not limited. However, the following method is preferable in which the resin melts are allowed to pass through a gap between two metal rolls or between a metal roll and a metal belt to contact the resin melts to the metal roll and/or the metal belt, so as to transfer a pattern carved on the surface of the roll or the belt to the surface of the resin film formed. This method is preferable because the profile accuracy of the surface of the film is improved to enhance the decorative property of the film. Alternatively, the surface of a metal roll and the surface of an elastic metal roll are allowed to contact to the both surfaces of the co-extruded resin melts. This method is advantageous to reduce the strain of the resulting film during the molding and to reduce anisotropy in strength and thermal shrinkage of the film. For example, the elastic metal roll comprises a shaft roll and a cylindrical metallic thin layer which is arranged to cover the outer circumference of the shaft roll and to which the resin melt contacts, wherein a fluid such as water or an oil, the temperature of which is controlled, is sealed between the shaft roll and the metallic thin layer, or the elastic metal roll comprises a rubber roll the surface of which is wrapped with a metal belt.

The multilayer film thus obtained preferably has a thickness of from 20 to 200 μm, more preferably from 30 to 150 μm, still more preferably from 50 to 100 μm. A multilayer film having a too large thickness requires a long time in a molding process for producing an interior material for automobiles, and is low in effect to improve the physical properties and designability thereof, and increases costs. On the other hand, a multilayer film having a too small thickness is difficult to form by extrusion because of the restriction on machinery, and has lower strength at break, and the probability to cause failures in manufacturing increases. The thickness of the multilayer film can be controlled by adjusting a film-forming speed, the thickness of a discharge port of a T die or the gap between rolls.

The thickness of the layer (A) formed of the polycarbonate resin is preferably from 10 to 80% of the total thickness of the multilayer film. When the layer (A) is too thin, the resultant multilayer film becomes fragile and cracky. The thickness of the layer (B) formed of the composition of the methacrylic resin and the acrylic rubber particles is preferably 10 μm or more, more preferably 15 μm or more, still more preferably 20 μm or more. When the layer (B) is too thin, the surface hardness of the resultant film decreases. When the layers (B) are laminated on the both surfaces of the layer (A), the thickness of each layer (B) is preferably 10 μm or more, more preferably 15 μm or more, still more preferably 20 μm or more.

The multilayer film of the present invention for use in the simultaneous injection molding-lamination method is preferably used as a decorative film. In view of a decorative property and a surface hardness of the resultant product, preferably, the multilayer comprises the layer (A) and the layers (B) formed on the both surfaces of the layer (A). As decorating means, the following methods are exemplified: a method of directly printing a wood-grain design or any other various designs on the surface of the multilayer film by continuous gravure printing, silk screen printing, etc.; a method of imparting a metal-plating like design to the surface of the multilayer film by a vapor deposition process or a sputtering process; or a method of laminating, on the multilayer film, other resin film having a decorative pattern formed thereon by printing or vapor deposition.

Further, a decorative sheet can be provided by laminating a thermoplastic resin sheet as a backing material on the printed or other decorative pattern-formed surface of the decorative film. Examples of a resin constituting the thermoplastic resin sheet include ABS resins, methacrylic resins, polyvinyl chloride resins, polyurethane resins, polyester resins, polyolefin resins, etc. The thickness of the thermoplastic resin sheet includes a film-range thickness and is preferably from about 0.1 to about 2 mm.

Then, the decorative film or sheet thus obtained is laminated on a molded article of a thermoplastic resin so that the resin layer having no decorative layer thereon of the decorative film or sheet is located on the surface side. Specifically, in case of the decorative film, the molded article of the thermoplastic resin is laminated on the decorative surface of the film. In case of the decorative sheet, the molded article of the thermoplastic resin is laminated on a surface of the decorative sheet on which the thermoplastic resin sheet is laminated. Thereby, a decorative molded article can be provided. Examples of the thermoplastic resin constituting the molded article include ABS resins, methacrylic resins, polyvinyl chloride resins, polyurethane resins, polyester resins, polyolefin resins, etc.

As a method for producing a decorative molded article, a simultaneous injection molding-lamination method is employed. For example, this method is carried out as follows: the decorative film or sheet which has not been pre-molded is inserted in an injection mold, and a resin melt is injected into the mold to form an injection-molded article with simultaneously laminating the decorative film or sheet on the molded article (sometimes referred to as a narrowly-defined simultaneous injection molding-lamination method); or the decorative film or sheet is pre-molded by vacuum forming or pressure forming and then inserted in an injection mold, and a resin melt is injected into the mold to form an injection-molded article with simultaneously laminating the decorative film or sheet on the molded article (referred to as an insert molding method); or the decorative film or sheet is pre-molded in an injection mold by vacuum forming or pressure forming, and a resin melt is then injected into the mold to form an injection-molded article with simultaneously laminating the decorative film or sheet on the molded article (referred to as an in-mold molding method). The simultaneous injection molding-lamination method is described in detail, for example, in JP-B-63-6339, JP-B-4-9647 and JP-A-7-9484.

### EXAMPLES

Hereinafter, the present invention will be illustrated with reference to the Examples, which they do not limit the scope of the present invention in any way. In Examples, “%” and “parts” indicating contents or amounts are by weight, unless otherwise specified.

As a methacrylic resin, there were used pellets of a thermoplastic polymer (glass transition temperature: 104° C.) prepared by bulk polymerization of a monomer mixture containing 97.8% of methyl methacrylate and 2.2% of methyl acrylate. Here, the glass transition temperature was an extrapolated glass transition-starting temperature which was determined at a heating rate of 10° C./min. by differential scanning calorimetry according to JIS K7121: 1987.

Acrylic rubber particles (A) used were spherical rubber particles with a three-layer structure produced by the emulsion polymerization method, each particle having an innermost layer formed of a hard polymer prepared by polymerization of a monomer mixture containing 93.8% of methyl methacrylate, 6% of methyl acrylate and 0.2% of allyl methacrylate; an intermediate layer formed of an elastic polymer prepared by polymerization of a monomer mixture containing 81% of butyl acrylate, 17% of styrene and 2% of allyl methacrylate; and an outermost layer formed of a hard polymer prepared by polymerization of a monomer mixture containing 94% of methyl methacrylate and 6% of methyl acrylate, in which the weight ratio of the innermost layer/the intermediate layer/the outermost layer was 35/45/20; and the average particle size of the intermediate elastic polymer layer was 0.22 μm.

Acrylic rubber particles (B) used were spherical rubber particles with a two-layer structure produced by the emulsion polymerization method, each particle having an inner layer formed of an elastic polymer prepared by polymerization of a monomer mixture containing 81% of butyl acrylate, 17% of styrene and 2% of allyl methacrylate; and an outer layer formed of a hard polymer prepared by polymerization of a monomer mixture containing 94% of methyl methacrylate and 6% of methyl acrylate, in which the weight ratio of the inner layer/the outer layer was 80/20; and the average particle size of the inner elastic polymer layer was 0.08 μm.

The average particle sizes of the elastic polymer layers of the acrylic rubber particles (A) and (B) were measured by the following method.

Measurement of Average Particle Size of Elastic Polymer Layer

A film was formed from a mixture of the acrylic rubber particles and the methacrylic resin, and was cut into pieces with appropriate sizes. The piece of the film was immersed in a 0.5% aqueous solution of ruthenium tetraoxide at room temperature for 15 hours to dye the elastic copolymer layers of the rubber particles. The film sample was cut with a microtome to obtain a sample piece with a thickness of about 80 nm, which was then photographed using a transmission electron microscope. From this photograph, 100 dyed elastic copolymer layers were randomly selected, and the particle sizes of the selected layers were calculated. A number-average particle size was used as an average particle size.

As a polycarbonate resin, CALIBRE 301-10 (available from Sumitomo Dow Limited) was used.

### Example 1-7

The pellets of the methacrylic resin and the acrylic rubber particles (A) or (B) were mixed in the ratio shown in Table 1 with a SUPER MIXER, and the mixture was melt-kneaded in a twin-screw extruder to obtain pellets of a methacrylic resin composition. Then, the pellets of the polycarbonate resin were molten in a 65 mmφ single screw extruder (manufactured by Toshiba Machine Co., Ltd.), and the pellets of the methacrylic resin composition was molten in a 45 mmφ single screw extruder (manufactured by Toshiba Machine Co., Ltd.) (Examples 1, 4, 6 and 7); or the pellets of the polycarbonate resin were molten in a 45 mmφ single screw extruder (manufactured by Toshiba Machine Co., Ltd.), and the pellets of the methacrylic resin composition was molten in a 65 mmφ single screw extruder (manufactured by Toshiba Machine Co., Ltd.) (Examples 2, 3 and 5). The respective melts were laminated on and integrated each other by the feed block method, and the integrated laminate was extruded through a T-die set at 275° C. to obtain a film-form material. This film-form material was sandwiched between a pair of metal rolls having smooth surfaces so as to shape the film-form material. Thus, a multilayer film with a three-layer structure having a total thickness of 75 μm was obtained. The multilayer film was evaluated by the following tests. The results are shown in Table 1.

Thermal Shrinkage

A square test piece (120 mm×120 mm) was cut out from the film, and this test piece was left to stand still in an oven set at 120° C. for 30 minutes. Then, the test piece was removed from the oven and cooled. After that, the length of the test piece was measured in the machine direction (MD) during the film extrusion-molding process and a transverse direction (TD) perpendicular to the MD, and the change of the length from the length of the test piece measured prior to the test was expressed in percentage. In this regard, a positive percentage means shrinkage, and a negative percentage means elongation.

Pencil Hardness

Pencil hardness was measured according to JIS K 5600.

Simultaneous Injection Molding-Lamination Test

The resultant film was cut to obtain a film piece of 15 cm×25 cm. This film piece was applied to the stationary part of an injection mold for molding a flat plate having a thickness (or depth) of 3 mm and a size of 12 cm×20 cm, so that the film piece run off the edges of the mold cavity. The mold was closed, and then, a methacrylic resin (Sumipex MH manufactured by Sumitomo Chemical Company, Limited) was injected with an injection-molding machine (IS130FII-3AV, manufactured by Toshiba Machine Co., Ltd.) to be integrated with the film. The temperature of the injection mold was 60° C.; the temperature of the methacrylic resin was 245° C.; the injection pressure was 32%; and the cooling time was 40 seconds. The portion of the film running off the cavity edge was folded along the boundary with the injection-molded portion of the film, and the condition of the bent portion of the film was observed. The film was evaluated according to the following criteria:

A: neither cracking nor peeling was observed in the film
B: no peeling of the film occurred, but cracking occurred
C: no cracking of the film occurred, but peeling occurred

### Comparative Examples 1-2

The pellets of the methacrylic resin and the acrylic rubber particles (A) or (B) were mixed in the ratio shown in Table 1 with a SUPER MIXER, and the mixture was melt-kneaded in a twin-screw extruder to obtain pellets of a methacrylic resin composition. Then, the pellets of the methacrylic resin composition were molten in a 65 mmφ single screw extruder (manufactured by Toshiba Machine Co., Ltd.), and the melt was extruded through a T die set at 275° C. to obtain a film-form material. This film-form material was sandwiched between a pair of metal rolls having smooth surfaces so as to shape the film-form material. Thus, a single-layer methacrylic resin film with a thickness of 75 μm was obtained. This film was evaluated in the same manners as described above. The results are shown in Table 1.

### Comparative Example 3

The pellets of a polycarbonate resin were molten in a 65 mmφ single screw extruder (manufactured by TOSHIBA MACHINE CO., LTD.) and the melt was extruded through a T die set at 275° C., and the resulting film-form material was sandwiched between a pair of metal rolls having smooth surfaces so as to shape the film-form material. Thus, a single-layer polycarbonate resin film with a thickness of 75 μm was obtained. The film was evaluated in the same manners as described above. The results are shown in Table 1.

TABLE 1

| | | | | | | | Simultaneous |
|---|---|---|---|---|---|---|---|
| | Layer (B) | | | | | | injection |
| | Methacrylic | Acrylic rubber | | Layer thickness | Thermal | | molding- |
| Example | resin | particles | | Layer (B)/Layer (A)/Layer (B) | shrinkage | Pencil | lamination |
| No. | (parts) | Kind | Parts | (unit: μm) | (%) | hardness | test |
| Ex. 1 | 80 | A | 20 | 10/55/10 | 0.6 | H | A |
| Ex. 2 | 80 | A | 20 | 20/35/20 | 2.0 | H | A |
| Ex. 3 | 80 | A | 20 | 30/15/30 | 11.0 | H | A |
| Ex. 4 | 80 | A | 20 | 5/65/5 | 0.4 | F | A |
| Ex. 5 | 80 | A | 20 | 35/5/35 | 19.5 | H | A |
| Ex. 6 | 70 | B | 30 | 10/55/10 | 0.5 | HB | A |
| Ex. 7 | 50 | B | 50 | 10/55/10 | 0.5 | HB | A |
| C. Ex. 1 | 80 | A | 20 | 75/—/— | 27.0 | H | C |
| C. Ex. 2 | 70 | B | 30 | 75/—/— | 18.0 | HB | B |
| C. Ex. 3 | — | — | — | —/75/— | 0.4 | 4B | C |

What is claimed is:

1. A multilayer film for use in a simultaneous injection molding-lamination method comprising a layer (A) formed of a polycarbonate resin and a layer (B) formed of a methacrylic resin and acrylic rubber particles, which is laminated on at least one surface of the layer (A).

2. The multilayer film according to claim 1, wherein the methacrylic resin is a polymer prepared by polymerizing 50 to 100% by weight of an alkyl methacrylate, 0 to 50% by weight of an alkyl acrylate, and 0 to 49% by weight of a monomer other than the alkyl methacrylate and alkyl acrylate.

3. The multilayer film according to claim 1, wherein the acrylic rubber particles comprise an elastic polymer which is prepared by polymerizing 50 to 99.9% by weight of an alkyl acrylate, 0 to 49.9% by weight of an alkyl methacrylate, 0 to 49.9% by weight of a monofunctional monomer other than the alkyl methacrylate and alkyl acrylate, and 0.1 to 10% by weight of a polyfunctional monomer.

4. The multilayer film according to claim 3, wherein the acrylic rubber particles have a multilayer structure comprising an additional layer of a polymer formed outside the layer of said elastic polymer, wherein said polymer in the additional layer is prepared by polymerizing 50 to 100% by weight of an alkyl methacrylate, 0 to 50% by weight of an alkyl acrylate, 0 to 50% by weight of a monofunctional monomer other than the alkyl methacrylate and alkyl acrylate, and 0 to 10% by weight of a polyfunctional monomer.

5. The multilayer film according to claim 3, wherein the acrylic rubber particles have a multilayer structure comprising a further layer of a polymer formed inside the layer of said elastic polymer, wherein said polymer in the further layer is prepared by polymerizing 70 to 100% by weight of an alkyl methacrylate, 0 to 30% by weight of an alkyl acrylate, 0 to 30% by weight of a monofunctional monomer other than the alkyl methacrylate and alkyl acrylate, and 0 to 10% by weight of a polyfunctional monomer.

6. The multilayer film according to claim 4, wherein the acrylic rubber particles have a multilayer structure comprising a further layer of a polymer formed inside the layer of said elastic polymer, wherein said polymer in the further layer is prepared by polymerizing 70 to 100% by weight of an alkyl methacrylate, 0 to 30% by weight of an alkyl acrylate, 0 to 30% by weight of a monofunctional monomer other than the alkyl methacrylate and alkyl acrylate, and 0 to 10% by weight of a polyfunctional monomer.

7. The multilayer film according to claim 1, wherein the total thickness of the multilayer film is from 20 to 200 μm, the thickness of the layer (A) is from 10 to 80% of the total thickness, and the thickness of the layer (B) is at least 10 μm.

8. The multilayer film according to claim 1, wherein at least one of the layer (A) and the layer (B) contains organic or inorganic fine particles.

9. The multilayer film according to claim 1, which is formed by co-extruding the polycarbonate resin and a composition comprising the methacrylic resin and the acrylic rubber particles.

10. The multilayer film according to claim 1, wherein the layer (B) is laminated on one surface of the layer (A).

11. The multilayer film according to claim 1, wherein the layers (B) are laminated on both surfaces of the layer (A).

12. A decorative film comprising a multilayer film according to claim 10 which has a decorative pattern on the surface of the layer (A) of said multilayer film.

13. A decorative film comprising a multilayer film according to claim 11 which has a decorative pattern on one surface of said multilayer film.

14. A decorative sheet comprising a decorative film according to claim 12 and a thermoplastic resin sheet which is laminated on the decorative pattern-formed surface of said decorative film.

15. A decorative sheet comprising a decorative film according to claim 13 and a thermoplastic resin sheet which is laminated on the decorative pattern-formed surface of said decorative film.

16. A decorative molded article comprising a decorative film according to claim 12 and an injection-molded article of a thermoplastic resin which is laminated on the decorative pattern-formed surface of said decorative film.

17. A decorative molded article comprising a decorative film according to claim 13 and an injection-molded article of a thermoplastic resin which is laminated on the decorative pattern-formed surface of said decorative film.

18. A decorative molded article comprising a decorative sheet according to claim 14 on which a thermoplastic resin is injection molded.

19. A decorative molded article comprising a decorative sheet according to claim 15 on which a thermoplastic resin is injection molded.
